(19) United States
(12) Patent Application Publication
(10) Pub. No.: US 2003/0224094 A1
(43) Pub. Date: Dec. 4, 2003

(54) Potassium bicarbonate as a sweetness enhancer

(76) Inventor: Abraham Bakal, Parsippany, NJ (US)

Correspondence Address: CHURCH & DWIGHT CO., INC., 469 North Harrison Street, Princeton, NJ, 08543, US

(21) Appl. No.: 10/153,369

(22) Filed: May 22, 2002

(51) Int. Cl. A23L 1/236

(52) U.S. Cl. 426/548

(57) ABSTRACT

Potassium bicarbonate is used to provide sweetness to or to enhance the sweetness of ingestible and oral non-ingestible products.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF THE INVENTION

The invention relates to potassium bicarbonate, and the use thereof in ingestible and oral non-ingestible products. The invention further relates to the use of potassium bicarbonate as a sweetener or sweetness enhancer.

### BACKGROUND OF THE INVENTION

Potassium is an essential element in the diet of human beings. Unfortunately, many people do not consume sufficient amounts of potassium for maintaining optimal health, and potassium supplementation is necessary. Others, on certain drug regimens, require supplemental potassium because some of the medications they are on deplete potassium. Still others require potassium supplementation as part of general electrolyte replacement in the course of strenuous exercise or due to electrolyte loss in the course of any of a number of disease states. Potassium compounds are also used in oral care for pain desensitization, for sodium replacement in low sodium products, etc. It may also be used for leavening, buffering or pH adjustment, etc.

Whatever the reason for seeking potassium supplementation or the use of potassium in other contexts, many forms of oral potassium, especially in forms which expose the potassium compound to the person's taste receptors, has had a history of disagreeable taste. Much of this history comes from potassium chloride, which is variously described as having a metallic, bitter, unpleasant taste. Other typical organoleptic sensations with various potassium salts that have been well known include astringent, fishy, salty, and soapy sensations. These sensations make the use of potassium salts in forms which are not protected from the taste receptors disagreeable and result in consumer non-acceptance of the product. In contrast, some potassium salts (such as potassium citrate and potassium gluconate) have had somewhat better reputations or perceptions in terms of similar products, although even these salts have, in fact, negative sensory attributes, including aftertastes, in certain foods or carriers. However, there has not been any indication that a potassium salt could be used as a sweetener or sweetness enhancer without negative attributes, and specifically there has been no indication that potassium bicarbonate would be suitable as a such a sweetener.

### OBJECTS OF THE INVENTION

It is therefore an object of the invention to provide a method of sweetening an oral or ingestible product by incorporating potassium bicarbonate into such product.

It is another object of the invention to enhance the sweetness of an oral or ingestible product by the inclusion of potassium bicarbonate therein.

It is still a further object of the invention to supplement potassium to a mammal without negatively impacting the overall flavor of an oral or ingestible product by use of potassium bicarbonate as the potassium source for such supplementation.

It is still a further object of the invention to replace a portion or all of the sweeteners in a product, whether natural or artificial, through the use of potassium bicarbonate.

Yet another object of the invention is to provide a potassium bicarbonate containing product for use as a sweetening agent in oral products and ingestible products.

It is yet another object of the invention to provide a potassium sweetened and/or enriched beverage product which minimizes, and preferably avoids altogether, the previously known disagreeable tastes and aftertastes associated with potassium salts.

A still further object of the invention is to provide a potassium sweetened and/or enriched food product which minimizes, and preferably avoids altogether, the previously known disagreeable tastes associated with potassium salts.

A still further object of the invention is to provide a potassium sweetened and/or enriched baked, cooked, or processed food product which minimizes, and preferably avoids altogether, the previously known disagreeable tastes associated with potassium salts.

### BRIEF SUMMARY OF THE INVENTION

These and other objects of the invention can be achieved by utilizing potassium bicarbonate, either without other sweeteners or in combination with one or more nutritive or non-nutritive sweeteners, with and without additional potassium salts.

### BRIEF DESCRIPTION OF THE SEVERAL VIEWS OF THE DRAWING

Not Applicable

### DETAILED DESCRIPTION OF THE INVENTION

The present invention relates to a wide range of products which come in contact with taste receptors and for which sweetening or sweetness enhancement or sweetener replacement is desirable. These include, without being limited to,

a) beverages, including unsweetened and sweetened, flavored and unflavored water, mineral water, sparkling waters (carbonated or effervescent), coffees, teas, sport drinks, soft drinks, alcoholic drinks, nutritional drinks, drink mixes, dairy based drinks, juices, etc.;

b) meal replacement powders and bars; nutritional bars;

c) cereals (hot and cold), soups, gravies, etc., whether as mixes, instant, or ready to use;

d) meat replacements (including vegetable and soy-based products);

e) chewing gums; mints; lozenges; etc;

f) packaged sweeteners;

g) bakery products (including breads, muffins, pastries, etc); snack foods, etc.; and

h) oral care products such as toothpastes/toothpowders/toothgels, whitening strips, mouthwashes, etc for cleaning, whitening, breath freshening, prophylactic treatments, etc.

In each case, the amount of potassium bicarbonate used (expressed as mg of potassium) is typically in the range of about 10 mg to about 1000 mg potassium per 100 g of product. Preferably, the potassium bicarbonate is used in amounts of at least about 30 mg, more preferably at least about 50 mg, still more preferably in amounts of at least 75 mg of potassium per 100 g of product. Also preferably, the potassium bicarbonate is used in amounts of up to about 750 mg, more preferably up to about 700 mg, even more preferably up to about 650 mg, yet more preferably up to about 600 mg, still more preferably up to about 550 mg, even more preferably up to about 500 mg, still more preferably up to about 300 mg, still more preferably up to about 350 mg, yet more preferably up to about 250 mg, even more preferably up to about 225 mg, potassium per 100 g of product. Notwithstanding these general ranges, each product will have its own particular most advantageous concentration of potassium and such particular amounts can be readily determined by those of ordinary skill in the art.

When used as a combination or sole agent sweetener as an additive for products such as those above, the combined or single agent sweetener can contain higher amounts of potassium bicarbonate (including 100% potassium bicarbonate) so long as the directions for use indicate that the combination sweetener or single agent sweetener be used in amounts which would deliver potassium in amounts which do not exceed those limits stated above.

The potassium bicarbonate for use in the instant invention, can be potassium bicarbonate per se or the potassium bicarbonate can be prepared in situ, such as from the appropriate amounts of potassium carbonate or potassium hydroxide with a neutralizing acid to result in the desired potassium bicarbonate level.

In many formulations the use of potassium bicarbonate according to the invention improves or imparts a level of sweetness to the formulation, so that the use of other sweeteners may be reduced, even if only in small amounts. This is particularly useful in formulations having large amounts of sweeteners such as sugar alcohols such as sorbitol (as in formulations specifically for diabetics) as an excess of sorbitol can result in gas and diarrhea for many people. For other people, the amount of intake of the non-nutritive sweeteners is of concern while the amount of nutritive sweetener intake is of concern for others. In many food and beverage product formulations of these types, the sweeteners commonly employed can be reduced somewhat while retaining the appropriate level of sweetness. Alternatively, the sweetness level may be boosted without the addition of further sugars or artificial sweeteners. In some formulations, the sweetness provided by the potassium bicarbonate may eliminate the need for sweeteners at all and/or provide an overall pleasant taste profile not generally available from other potassium salts.

### EXAMPLES

The following abbreviations have been used throughout the following Examples. The % potassium for each potassium salt is given for convenience in conversions between weight potassium and weight of the particular salt:

| | |
|---|---|
| KC = potassium carbonate | 57.6% potassium |
| KBC = potassium bicarbonate | 39.1% potassium |
| KCl = potassium chloride | 52.5% potassium |
| KG = potassium gluconate | 16.7% potassium |
| KCIT = potassium citrate | 36.2% potassium |
| KL = potassium lactate | 30.5% potassium |
| KBT = potassium bitartrate | 20.8% potassium |
| MKP = mono potassium phosphate | 28.7% potassium |
| SBC = sodium bicarbonate | |

### Example 1

Potassium bicarbonate or potassium chloride are added to water in the concentrations set forth in Table I below and the sensory attributes indicated there are determined on a scale of 0 (none) to 8 (very strong). An “expert taste panel” trained to quantify sensory attributes and validated for reproducibility of its analysis is used to determine the sensory profile.

TABLE I

| | KBC | | | KCl | | |
|---|---|---|---|---|---|---|
| | Mg of Potassium/8 oz | | | Mg of Potassium/8 oz | | |
| Taste Attribute | 200 | 350 | 500 | 200 | 350 | 500 |
| Sweet | 1.1 | 2.1 | 2.1 | 0 | 0 | 0 |
| Sour | 0 | 0 | 0 | 0 | 0.1 | 0 |
| Salty | 0 | 0.2 | 0 | 0 | 2.3 | 0.3 |
| Bitter | 0 | 0 | 0 | 2.9 | 3.9 | 5.2 |
| pH | 8.21 | 8.30 | 8.40 | 6.00 | 6.23 | 6.53 |

This demonstrates that with equal amounts of potassium, potassium bicarbonate has a substantially better taste profile than potassium chloride. Potassium chloride in the above concentrations has no perceived sweetness, but has a significant perceived bitterness. In contrast potassium bicarbonate has no bitterness and a perceived sweetness.

### Example 2

Example 1 is repeated for potassium bicarbonate. Water samples having their pH adjusted with NaOH to match the pH of the potassium bicarbonate solutions were also tested as was an analogous solution having sodium bicarbonate instead of potassium bicarbonate. The sensory profile was determined and the results are set forth below in Table II. TABLE II

TABLE II

| | | | | Water pH | | | |
|---|---|---|---|---|---|---|---|
| | | | | adjusted to match | | | |
| | KBC Mg of | | | Potassium | | | |
| | Potassium/8 oz | | | sample at left | | | SBC |
| Taste Attribute | 200 | 350 | 500 | 200 | 350 | 500 | 200 mg Na |
| Sweet | 1.1 | 2.1 | 2.1 | 0 | 0 | 0 | 0 |
| Sour | 0 | 0 | 0 | 0 | 0 | 0 | 0 |
| Salty | 0 | 0.2 | 0 | 0 | 0 | 0 | 2 |
| Bitter | 0 | 0 | 0 | 0 | 0.8 | 1.5 | 0 |
| Other* | 0 | 0 | 0 | 0 | 0.5 | 2.0 | 3 |
| pH | 8.21 | 8.30 | 8.40 | 8.2 | 8.30 | 8.4 | 8.29 |

*Metallic or soapy

This demonstrates that plain water with its pH adjusted to match that of the potassium bicarbonate begins to have negative readings at pH 8.4 (corresponding to the pH of 500 mg K (as potassium bicarbonate) while the actual potassium bicarbonate solutions do not exhibit this, but in fact have a noticeable sweetness. The comparison with the sodium bicarbonate solution shows that as between sodium and potassium bicarbonates, the sweetness is due to the potassium compound, not the sodium compound. This data also demonstrates that the soapy and metallic sensations seen with sodium bicarbonate and the alkalinized water are absent in the potassium bicarbonate solutions tested. Also, the saltiness of the sodium bicarbonate is not present with potassium bicarbonate.

### Example 3

A sensory profile was determined for various potassium salts using amounts of the salts sufficient to deliver 500 mg potassium/8 oz water. The results are presented in Table III below:

TABLE III

| Taste Attribute | KC | KBC | KCl | KL | KBT | KG | KCIT | MKP |
|---|---|---|---|---|---|---|---|---|
| Sweet | 0.5 | 2.1 | 0 | 0.1 | 0 | 0.2 | 0.3 | 0 |
| Sour | 0 | 0 | 0 | 0.1 | 6.0 | 0 | 0 | 2.3 |
| Salty | 0.1 | 0 | 0.3 | 0.1 | 0 | 0 | 0 | 1.5 |
| Bitter | 6.1 | 0.5 | 5.2 | 1.3 | 0.1 | 0.1 | 5.7 | 0.5 |
| Other | 6.4 | 0 | 3.8 | 1.1 | 0 | 0.9 | 0 | 0 |
| (Description) | fishy | | metal | astringent | | astringent | | |
| pH | 11.3 | 8.78 | 6.53 | 6.67 | 3.92 | 6.97 | 8.23 | 4.91 |
| Viscosity | 5.0 | 5.0 | 5.0 | 5.0 | 5.0 | 5.0 | 5.0 | 5.0 |

This data shows that a sweetening effect is only seen with potassium with bicarbonate. Taking all of Examples 1-3 together, it is clear that the ability to use potassium as a sweetener or enhancer of sweetness without the bitterness commonly seen with many potassium salts is only possible with potassium bicarbonate.

This was repeated using the same salts in amounts sufficient to deliver 350 mg of potassium/8 oz of water. The results are presented in Table IV below:

TABLE IV

| Taste Attribute | KC | KBC | KCl | KL | KBT | KG | KCIT | MKP |
|---|---|---|---|---|---|---|---|---|
| Sweet | 1.2 | 2.1 | 0 | 0.2 | 0 | 0.9 | 1.8 | 0.2 |
| Sour | 0 | 0 | 0.1 | 0.2 | 6.0 | 0.2 | 0 | 3.0 |
| Salty | 0 | 0.2 | 2.3 | 0 | 0.2 | 0 | 0.1 | 2.0 |
| Bitter | 5.2 | 0 | 3.2 | 2.2 | 0.2 | 1.8 | 6.2 | 0.1 |
| Other | 5.2/3.9 | 0 | 4.3 | 2.2 | 0 | 2.2 | 0 | 0 |
| (Description) | metal/ | | metal | astringent | | astringent | | |
| | fishy | | | | | | | |
| pH | 11.05 | 8.45 | 6.0 | 6.07 | 3.5 | 6.5 | 7.8 | 4.67 |
| Viscosity | 5.0 | 5.0 | 5.0 | 5.0 | 5.0 | 5.0 | 5.0 | 5.0 |

### Example 4

A sensory profile is conducted as in Example 1 except that 5% sugar solution, potassium bicarbonate in various concentrations in 5% sugar, and pH adjusted 5% sugar solution are compared. The results are set forth In Table V below. This was repeated with 10% sugar instead of 5% and the results are reported in Table VI.

TABLE V

| | | 5% Sugar + KBC | | | 5% Sugar with pH | | |
|---|---|---|---|---|---|---|---|
| | | Mg of | | | adjusted to | | |
| | 5% | Potassium/8 oz | | | match pH of KBC | | |
| Taste Attribute | Sugar | 200 | 350 | 500 | 200 | 350 | 500 |
| Sweet | 3.5 | 5.5 | 6.8 | 7.5 | 2.8 | 2.6 | 2.8 |
| Sour | 0 | 0 | 0 | 0 | 0 | 0 | 0 |
| Salty | 0 | 0 | 0 | 0.7 | 0 | 0 | 0 |
| Bitter | 0 | 0 | 0 | 0 | 0.8 | 1.0 | 1.2 |
| Other* | 0 | 0 | 0.5 | 0.5 | 0 | 0 | 0 |
| pH | | 8.25 | 8.31 | 8.35 | 8.29 | 8.31 | 8.35 |

*Metallic or soapy

TABLE VI

| | | 10% Sugar + KBC | | | 10% Sugar with pH | | |
|---|---|---|---|---|---|---|---|
| | | Mg of Potassium/ | | | adjusted to | | |
| | 10% | 8 oz water | | | match pH of KBC | | |
| Taste Attribute | Sugar | 200 | 350 | 500 | 200 | 350 | 500 |
| Sweet | 5.8 | 7.0 | 7.1 | 7.0 | 5.8 | 6 | 5.8 |
| Sour | 0 | 0 | 0 | 0 | 0 | 0 | 0 |
| Salty | 0 | 0 | 0 | 0.0 | 0 | 0 | 0 |
| Bitter | 0 | 0 | 0 | 0.5 | 0 | 0.7 | 1.5 |
| Other* | 0 | 0 | 0 | 1.0 | 0 | 0.5 | 1 |
| pH | | 8.17 | 8.19 | 8.19 | 8.19 | 8.19 | 8.19 |

*Metallic or soapy

This example demonstrates the sweetness enhancement power of KBC when added at levels of 200 to 500 mg potassium per 8 oz (87 to 217 mg potassium per 100 g of solution). The data indicate that the sweetness enhancement in this case is as effective at lower concentrations as at higher concentrations of potassium. It also shows that the sweetness enhancement is not related to the pH of the solution.

### Example 5

A sensory profile is conducted as in Example 1 except that 4% sugar solution is compared with calcium saccharine alone (both pH unadjusted and pH adjusted), as well as calcium saccharine in combination with potassium bicarbonate, potassium gluconate, potassium chloride, and sodium bicarbonate. The potassium and sodium salts are used in amounts to deliver 175 mg of potassium (76 mg potassium per 100 g solution) per 8 oz solution or 175 mg sodium ion per 8 oz of solution. The calcium saccharine is used in an amount of 30 mg per 8 fluid oz of solution. The results are reported in Table VII below.

TABLE VII

| | | 30 mg Calcium Saccharine (CS)/8 oz + | | | | | |
|---|---|---|---|---|---|---|---|
| Taste | 4% | CS | + | + | + | + | + |
| Attribute | Sugar | only | KBC | pH adjust | KG | KCl | SBC |
| pH | | | 8.26 | 8.24 | | | |
| Sweet | 3.5 | 3.8 | 4.8 | 3.9 | 3.6 | 3.9 | 3.6 |
| Sour | 0 | 0 | 0 | 0 | 0.2 | 0 | 0 |
| Salty | 0 | 0 | 0 | 0 | 0 | 1.2 | 1.9 |
| Bitter | 0 | 1.0 | 0.5 | 0.4 | 0 | 3.3 | 0 |
| Other | 0 | 0 | 0 | 0 | 3.2 | 0.4 | 2.1 |
| Describe | | | | | astringent | metal | soapy |
| | | | | | soapy | | |

This example is repeated using 10% sugar and comparing it to 80 mg of calcium saccharine (alone or pH adjusted)/8 oz water, and 80 mg calcium saccharine with potassium bicarbonate (KBC), potassium chloride (KCl), potassium gluconate (KGluc), or sodium chloride in sufficient amounts to provide 125 mg of potassium per 8 oz solution (54 mg potassium per 100 g solution) or 125 mg sodium per 8 oz of solution. A sample adjusting the pH of the KGluc and KCI are also presented. The results are shown in Table VIII below.

TABLE VIII

| | | 80 mg Calcium Saccharine(CS)/8 oz + | | | | | | | |
|---|---|---|---|---|---|---|---|---|---|
| Taste | 10% | CS | + | + pH | + | + | + | + pH adj | + pH adj |
| Attribute | Sugar | only | KBC | adj | KG | KCl | SBC | KG | KCl |
| pH | | | 8.21 | 8.2 | | | | 8.2 | 8.2 |
| Sweet | 6.0 | 6.3 | 7.2 | 6.2 | 6.0 | 6.0 | 6.2 | 6.1 | 6 |
| Sour | 0 | 0 | 0 | 0 | 0 | 0 | 0 | 0 | 0 |
| Salty | 0 | 0 | 0 | 0 | 0 | 0 | 2.1 | 0 | 0 |
| Bitter | 0 | 3.5 | 1.3 | 3.5 | 4.5 | 2.0 | 0.5 | 4.1 | 2.1 |
| Other | 0 | 0 | 0 | 0 | 0 | 2.6 | 2.8 | 0 | 3 |
| Describe | | | | | | metal | soapy | | metal |

This clearly shows the enhanced sweetness of potassium bicarbonate/calcium saccharine solutions over combinations of calcium saccharine and other potassium salts or other bicarbonate salts.

### Example 6

A similar sensory profile test was conducted with various potassium salts in a 10% sugar solution. The salts were used in concentrations to deliver 350 mg of potassium per 8 oz of 10% sugar solution. The results are shown in Table IX below.

TABLE IX

| Taste | | | | | | | |
|---|---|---|---|---|---|---|---|
| Attribute | Sweet | Sour | Salty | Bitter | Other | Description | pH |
| KC | 3.8 | 0 | 0 | 4.3 | 4.1 | fishy | 10.7 |
| KBC | 5.5 | 0 | 0.3 | 0 | 0 | | 8.38 |
| KCl | 3.0 | 0 | 0 | 2.0 | 3.0 | astringent | 6.23 |
| KL | 4.5 | 0 | 0 | 0 | 0.3 | metallic | 6.22 |
| KBT | 2 | 5.5 | 0 | 0 | 0 | | 3.61 |
| KG | 4.8 | 0 | 0 | 1.0 | 0 | | 6.38 |
| KCIT | 4.2 | 0 | 0 | 4.0 | 0 | | 8.07 |
| MKP | 3 | 2.0 | 0.6 | 0 | 0 | | 4.77 |

This shows that potassium bicarbonate in combination with sugar retains more of the sweetness of the sugar solution than any of the other potassium salts.

### Example 7

A sensory profile similar to that in Example 1 was conducted using various potassium salts (at 350 mg potassium per 8 oz) in 1.5% oil emulsion and compared to the base emulsion without any potassium salt. The results appear in Table X

TABLE X

| Taste | | | | | | | |
|---|---|---|---|---|---|---|---|
| Attribute | Sweet | Sour | Salty | Bitter | Other | Description | pH |
| KC | 0.2 | 0 | 0 | 4.3 | 3.1 | fishy | 10.95 |
| | | | | | 4 | metallic | |
| KBC | 2.3 | 0 | 0 | 0 | 2 | oil | 8.59 |
| KCl | 0 | 0 | 0.5 | 3.1 | 3.1 | metallic | 7.04 |
| KL | 0 | 0 | 0 | 1.9 | 2.1 | astringent | 6.97 |
| KBT | 0 | 5.4 | 0 | 0 | 0.5 | oil | 3.73 |
| KG | 0 | 0 | 0 | 1.9 | 2.5 | astringent | 7.5 |
| KCIT | 0 | 0 | 0 | 5.7 | 1.5 | oil | 8.4 |
| MKP | 0 | 2.8 | 1.1 | 0 | 2.2 | oil | 5.39 |
| 1.5% oil | 0 | 0 | 0 | 0 | 2.2 | oil | 7.65 |
| emulsion | | | | | | | |

This example demonstrates that in oil emulsions, the only potassium salt to have any appreciable sweetening power is potassium bicarbonate.

### Example 8

A sensory profile similar to that in Example 1 was conducted using various potassium salts (at 350 mg potassium per 8 oz) in 0.1% xanthan gum solution and compared to the base 0.1% xanthan gum solution without any potassium salt. The results appear in Table XI

TABLE XI

| Taste | | | | | | | |
|---|---|---|---|---|---|---|---|
| Attribute | Sweet | Sour | Salty | Bitter | Other | Description | pH |
| KC | 0.3 | 0 | 0 | 5.1 | 5.1 | metallic | 10.98 |
| | | | | | 4.1 | fishy | |
| KBC | 1.4 | 0 | 0 | 0 | 0 | | 8.4 |
| KCl | 0 | 0 | 2.0 | 2.7 | 2.1 | metallic | 5.65 |
| KL | 0 | 0 | 0 | 1.3 | 1.1 | astringent | 6.27 |
| KBT | 0 | 0 | 0 | 5.8 | 0 | | 3.63 |
| KG | 0 | 0 | 0 | 0.5 | 1.1 | astringent | 6.38 |
| KCIT | 1 | 0 | 0 | 4.1 | 0 | | 7.75 |
| MKP | 0 | 2.7 | 0.8 | 0 | 0 | | 4.87 |
| 0.1% | 0 | 0 | 0 | 0.3 | 0 | | 5.96 |
| xanthan gum | | | | | | | |

This example demonstrates that in xanthan gum solutions, the only potassium salt to have any appreciable sweetening power without any bitterness is potassium bicarbonate. Similar results are obtained when 0.1% guar gum is used in place of the 0.1% xanthan gum.

### Example 9

A sensory profile similar to that in Example 1 was conducted using various potassium salts (at 350 mg potassium per 8 oz) in 1% (rice) starch solution and compared to the base 1% rice starch solution without any potassium salt. The results appear in Table XII.

TABLE XII

| Taste | | | | | | | |
|---|---|---|---|---|---|---|---|
| Attribute | Sweet | Sour | Salty | Bitter | Other | Description | pH |
| KC | 0 | 0 | 0 | 5 | 5 | metallic | 10.8 |
| | | | | | 4.1 | fishy | |
| KBC | 1.2 | 0 | 0 | 0 | 0 | | 8.69 |
| KCl | 0 | 0 | 2.1 | 3.5 | 4.1 | metallic | 6.39 |
| KL | 0 | 0 | 0 | 0.7 | 0.5 | astringent | 6.34 |
| KBT | 0 | 0 | 0 | 6.5 | 0 | | 3.63 |
| KG | 0 | 0 | 0 | 0.3 | 0.6 | astringent | 6.68 |
| KCIT | 0 | 0 | 0 | 6 | 0 | | 7.76 |
| MKP | 0 | 2.9 | 1.8 | 0 | 0 | | 4.97 |
| 1% | 0 | 0 | 0 | 0 | 0.2 | starch | 6.34 |
| rice starch | | | | | | | |

Once again, the only potassium salt to have any sweetness recognized in its profile is potassium bicarbonate.

### Example 10

A sensory test was conducted using various potassium salts at the amounts in the table (equal amounts of potassium) in a Lemon/Lime flavored water base. The results of overall flavor, bitterness and any fishy, metallic, or astringent sensation are reported in Table XIII.

TABLE XIII

| | Control | KC | KBC | KCl | KG | KCIT | KC/KBC |
|---|---|---|---|---|---|---|---|
| Ingredient | | | | | | | |
| Water (filtered) | 98.25 | 97.99 | 97.88 | 97.97 | 97.38 | 97.85 | 97.93 |
| Sugar | 1.00 | 1.00 | 1.00 | 1.00 | 1.00 | 1.00 | 1.00 |
| Lemon/Lime Flavor | 0.75 | 0.75 | 0.75 | 0.75 | 0.75 | 0.75 | 0.75 |
| K Carbonate | 0 | 0.26 | 0 | 0 | 0 | 0 | 0.13 |
| K Bicarbonate | 0 | 0 | 0.37 | 0 | 0 | 0 | 0.19 |
| K Chloride | 0 | 0 | 0 | 0.28 | 0 | 0 | 0 |
| K Gluconate | 0 | 0 | 0 | 0 | 0.87 | 0 | 0 |
| K Citrate | 0 | 0 | 0 | 0 | 0 | 0.4 | 0 |
| Sensory Attributes | | | | | | | |
| Overall Flavor | 3.2 | 1.0 | 4.0 | 1.5 | 2.8 | 1.8 | 1.0 |
| Bitterness | 0 | 3.0 | 0 | 4.0 | 0 | 1.8 | 2.0 |
| Other | 0 | 2.0 | 0 | 1.0 | 0.4 | 0 | 2.0 |
| | | Fishy | | Metal | Astring | | Fishy |

This demonstrates that of the salts tested, only potassium bicarbonate enhanced the overall flavor and sweetness of the flavored drink, and did not contribute to negative sensations.

### Example 11

### Meal Replacement

Meal replacement formulations were prepared according to the formulations set forth in Table XIV, where the amounts given are set forth in grams per serving. The various potassium salts are used in amounts to deliver the same amount of potassium per serving in all cases. A sensory test is then conducted with overall flavor, bitterness, sweetness, and any fishy, metallic, or sour component noted and reported in Table XIV.

TABLE XIV

| Ingredient | Control | KC | KBC | KCl | KG | KCIT | MKP | KBT |
|---|---|---|---|---|---|---|---|---|
| Sugars and carbohydrates | 16.00 | 16.00 | 16.00 | 16.00 | 16.00 | 16.00 | 16.00 | 16.00 |
| Whey Protein and | 6.00 | 6.00 | 6.00 | 6.00 | 6.00 | 6.00 | 6.00 | 6.00 |
| Calcium Caseinate | | | | | | | | |
| Nonfat milk solids | 2.00 | 2.00 | 2.00 | 2.00 | 2.00 | 2.00 | 2.00 | 2.00 |
| Gums | 4.40 | 4.40 | 4.40 | 4.40 | 4.40 | 4.40 | 4.40 | 4.40 |
| Powd. Shortening | 3.00 | 3.00 | 3.00 | 3.00 | 3.00 | 3.00 | 3.00 | 3.00 |
| Flavor | 1.00 | 1.00 | 1.00 | 1.00 | 1.00 | 1.00 | 1.00 | 1.00 |
| KC | 0.00 | 0.50 | 0.00 | 0.00 | 0.00 | 0.00 | 0.00 | 0.00 |
| KBC | 0.00 | 0.00 | 0.73 | 0.00 | 0.00 | 0.00 | 0.00 | 0.00 |
| KCl | 0.00 | 0.00 | 0.00 | 0.55 | 0.00 | 0.00 | 0.00 | 0.00 |
| KG | 0.00 | 0.00 | 0.00 | 0.00 | 0.17 | 0.00 | 0.00 | 0.00 |
| KCIT | 0.00 | 0.00 | 0.00 | 0.00 | 0.00 | 0.78 | 0.00 | 0.00 |
| MKP | 0.00 | 0.00 | 0.00 | 0.00 | 0.00 | 0.00 | 0.99 | 0.00 |
| KBT | 0.00 | 0.00 | 0.00 | 0.00 | 0.00 | 0.00 | 0.00 | 1.37 |
| Total | 32.4 | 32.9 | 33.13 | 32.95 | 34.1 | 33.18 | 33.39 | 33.77 |
| Sensory Attribute | Control | KC | KBC | KCl | KG | KCIT | MKP | KBT |
| Overall Flavor | 6 | 5 | 6 | 3 | 6 | 4 | 6 | 6 |
| Bitterness | 0 | 0 | 0 | 3 | 0 | 0 | 0 | 0 |
| Sweetness | 4 | 3 | 5.1 | 2 | 4 | 3 | 2 | 0 |
| Other | 0 | 3 | 0 | 3 | 0 | 2 | 3 | 6 |
| | | Fishy | | Metal | | Metal | Sour | Sour |

The data demonstrates that only potassium bicarbonate increases the sweetness of the control product.

### Example 12

### Hot Cereal

Hot cereal formulations were prepared according to the formulations set forth in Table XV, where the amounts given are set forth in % of product. The various potassium salts are used in amounts to deliver the same amount of potassium per serving in all cases. A sensory test is then conducted with overall flavor, bitterness, sweetness (if present), and any fishy, metallic, or sour component noted and reported in Table XV.

TABLE XV

| Ingredient | Control | KC | KBC | KCl | KG | KCIT | KC/KBC |
|---|---|---|---|---|---|---|---|
| Rolled Quick Oats | 67.41 | 66.07 | 65.47 | 65.95 | 65.87 | 65.35 | 66.07 |
| Sugar | 19.67 | 19.67 | 19.67 | 19.67 | 19.67 | 19.67 | 19.67 |
| Bakers Cinnamon | 0.84 | 0.84 | 0.84 | 0.84 | 0.84 | 0.84 | 0.84 |
| Salted Flour | 0.84 | 0.84 | 0.84 | 0.84 | 0.84 | 0.84 | 0.84 |
| Apples | 11.24 | 11.24 | 11.24 | 11.24 | 11.24 | 11.24 | 11.24 |

low moisture tenderized, sulfured (½ × ⅜ × ¼)

| KC | 0.00 | 1.34 | 0.00 | 0.00 | 0.00 | 0.00 | 0.67 |
|---|---|---|---|---|---|---|---|
| KBC | 0.00 | 0.00 | 1.94 | 0.00 | 0.00 | 0.00 | 0.97 |
| KCl | 0.00 | 0.00 | 0.00 | 1.46 | 0.00 | 0.00 | 0.00 |
| KG | 0.00 | 0.00 | 0.00 | 0.00 | 4.54 | 0.00 | 0.00 |
| KCIT | 0.00 | 0.00 | 0.00 | 0.00 | 0.00 | 2.06 | 0.00 |
| Sensory Attributes | Control | KC | KBC | KCl | KG | KCIT | KC/KBC |
| Overall Flavor | 5 | 2 | 6.5 | 5 | 6.8 | 5 | 4 |
| Bitterness | 0 | 3 | 0 | 1.5 | 0 | 1 | 1 |
| Other | 0 | 4 | 0 | 0.8 | 0 | 1.8 | 1.5 |
| | | Fishy | Sweet | Metal | | Sour | Fishy |

### Example 13

### Hot Soup

Hot soup formulations (chicken flavored vegetable) were prepared according to the formulations set forth in Table XVI, where the amounts given are set forth in % of product. The various potassium salts are used in amounts to deliver the same amount of potassium per serving in all cases. A sensory test is then conducted with overall flavor, bitterness, sweetness (if present), and any fishy, metallic, or sour component noted and reported in Table XVI.

TABLE XVI

| Ingredient | Control | KC | KBC | KCl | KG | KCIT |
|---|---|---|---|---|---|---|
| Water | 77.58 | 77.38 | 77.29 | 77.27 | 76.89 | 77.36 |
| cooked Grain Rice | 8.33 | 8.33 | 8.33 | 8.33 | 8.33 | 8.33 |
| Vegetables | 9.57 | 9.57 | 9.57 | 9.57 | 9.57 | 9.57 |
| Rice Starch | 1.67 | 1.67 | 1.67 | 1.67 | 1.67 | 1.67 |
| Tomato Juice Conc. | 1.04 | 1.04 | 1.04 | 1.04 | 1.04 | 1.04 |
| Vegetable Oil | 1.04 | 1.04 | 1.04 | 1.04 | 1.04 | 1.04 |
| Flavor | 0.63 | 0.63 | 0.63 | 0.63 | 0.63 | 0.63 |
| Spices | 0.13 | 0.13 | 0.13 | 0.13 | 0.13 | 0.13 |
| KC | 0.00 | 0.20 | 0.00 | 0.00 | 0.00 | 0.00 |
| KBC | 0.00 | 0.00 | 0.29 | 0.00 | 0.00 | 0.00 |
| KCl | 0.00 | 0.00 | 0.00 | 0.22 | 0.00 | 0.00 |
| KG | 0.00 | 0.00 | 0.00 | 0.00 | 0.69 | 0.00 |
| KCIT | 0.00 | 0.00 | 0.00 | 0.00 | 0.00 | 0.31 |
| Sensory Attributes | Control | KC | KBC | KCl | KG | KCIT |
| Overall Flavor | 2 | 0.8 | 4.6 | 0.5 | 2.1 | 3.5 |
| Bitterness | 0 | 2 | 0 | 4.2 | 0 | 0 |
| Other | 0 | 3.9 | 0 | 2 | 0 | 0.5 |
| | | Fishy | Sweet | Metal | | Sour |

The above data demonstrate that of the potassium salts tested, potassium bicarbonate was the only one to impart a sweetness note without introduction of a negative note. At the same time, the potassium bicarbonate significantly improved the overall flavor relative to control and potassium citrate.

### Example 14

### Meat Replacement

Meat Replacement (Veggie Patty) formulations were prepared according to the formulations set forth in Table XVII, where the amounts given are set forth in % of product. The various potassium salts are used in amounts to deliver the same amount of potassium per serving in all cases. A sensory test is then conducted with overall flavor, bitterness, sweetness (if present), and any fishy, metallic, or sour component noted and reported in Table XVII.

TABLE XVII

| Ingredient | Control | KC | KBC | KCl | KG | KCIT |
|---|---|---|---|---|---|---|
| Phase A | | | | | | |
| Water | 29.65 | 29.517 | 29.47 | 29.50 | 29.20 | 29.45 |
| Texturized Veg. | 20.00 | 20.00 | 20.00 | 20.00 | 20.00 | 20.00 |
| Protein | | | | | | |
| Phase B | | | | | | |
| Frozen Vegetables | 37.90 | 37.90 | 37.90 | 37.90 | 37.90 | 37.90 |
| Soybean oil | 3.80 | 3.80 | 3.80 | 3.80 | 3.80 | 3.80 |
| Flavor | 1.20 | 1.20 | 1.20 | 1.20 | 1.20 | 1.20 |
| Phase C | | | | | | |
| Soy Protein isolate | 2.00 | 2.00 | 2.00 | 2.00 | 2.00 | 2.00 |
| Binder | 4.70 | 4.70 | 4.70 | 4.70 | 4.70 | 4.70 |
| Starch | 0.75 | 0.75 | 0.75 | 0.75 | 0.75 | 0.75 |
| KC | 0.00 | 0.133 | 0.00 | 0.00 | 0.00 | 0.00 |
| KBC | 0.00 | 0.00 | 0.19 | 0.00 | 0.00 | 0.00 |
| KCl | 0.00 | 0.00 | 0.00 | 0.15 | 0.00 | 0.00 |
| KG | 0.00 | 0.00 | 0.00 | 0.00 | 0.45 | 0.00 |
| KCIT | 0.00 | 0.00 | 0.00 | 0.00 | 0.00 | 0.20 |
| Sensory Attributes | Control | KC | KBC | KCl | KG | KCIT |
| Overall Flavor | 2.4 | 1.8 | 3.5 | 4.2 | 4.6 | 3 |
| Bitterness | 0 | 0 | 0 | 1.2 | 0 | 0 |
| Other | 0 | 2.2 | 0 | 0 | 0 | 2 |
| | Needs | Fishy | Sweet | Metal | slight | Sour |
| | Salt | | | | chalky | |

Once again, potassium bicarbonate is the only potassium salt tested which imparts sweetness and improves overall flavor without also introducing metallic, chalky, or sour notes into the sensory profile.

### Example 15

### Chocolate Flavored Nutritional Bars

Chocolate Flavored Nutritional Bar formulations were prepared according to the formulations set forth in Table XVII, where the amounts given are set forth in % of product. The various potassium salts are used in amounts to deliver the same amount of potassium per serving in all cases. A sensory test is then conducted with overall flavor, bitterness, sweetness (if present), and any fishy, metallic, or sour component noted and reported in Table XVIII.

TABLE XVIII

| Ingredient | Control | KC | KBC | KCl | KG | KCIT |
|---|---|---|---|---|---|---|
| High Fructose | 32.8 | 32.8 | 32.8 | 32.8 | 32.8 | 32.8 |
| And sugar syrup | | | | | | |
| Whey Protein and | 25.00 | 25.00 | 25.00 | 25.00 | 25.00 | 25.00 |
| Ca Caseinate | | | | | | |
| Corn Syrup | 10.40 | 10.40 | 10.40 | 10.40 | 10.40 | 10.40 |
| Water | 3.20 | 2.70 | 2.47 | 2.65 | 1.50 | 2.43 |
| Rice Flour | 8.20 | 8.20 | 8.20 | 8.20 | 8.20 | 8.20 |
| Soy Protein Isolate | 7.00 | 7.00 | 7.00 | 7.00 | 7.00 | 7.00 |
| Cocoa D-11-S | 4.00 | 4.00 | 4.00 | 4.00 | 4.00 | 4.00 |
| Non-fat milk solids, | 4.00 | 4.00 | 4.00 | 4.00 | 4.00 | 4.00 |
| Oil | 3.80 | 3.80 | 3.80 | 3.80 | 3.80 | 3.80 |
| Cocoa Flav. | 1.00 | 1.00 | 1.00 | 1.00 | 1.00 | 1.00 |
| Lecithin | 0.60 | 0.60 | 0.60 | 0.60 | 0.60 | 0.60 |
| KC | 0.00 | 0.50 | 0.00 | 0.00 | 0.00 | 0.00 |
| KBC | 0.00 | 0.00 | 0.73 | 0.00 | 0.00 | 0.00 |
| KCl | 0.00 | 0.00 | 0.00 | 0.55 | 0.00 | 0.00 |
| KG | 0.00 | 0.00 | 0.00 | 0.00 | 1.70 | 0.00 |
| KCIT | 0.00 | 0.00 | 0.00 | 0.00 | 0.00 | 0.77 |
| Sensory Attributes | Control | KC | KBC | KCl | KG | KCIT |
| Overall Flavor | 5.2 | 5.6 | 5.9 | 4.8 | 5.1 | 5.6 |
| Bitterness | 0 | 0 | 0 | 2.1 | 0 | 0 |
| Other | 0 | 0 | 0 | 2 | 0 | 1.8 |
| | | | Visual | less | | Sour |
| | | | Specks | sweet | | |
| | | | | slight | | |
| | | | | metal | | |

Once again, potassium bicarbonate imparts the greatest flavor enhancement to the control product of all of the potassium salts tested.

### Example 16

### Gravy Product

Gravy product formulations were prepared according to the formulations set forth in Table XIX, where the amounts given are set forth in % of product. The various potassium salts are used in amounts to deliver the same amount of potassium per serving in all cases. A sensory test is then conducted with overall flavor, bitterness, sweetness (if present), and any fishy, metallic, or sour component noted and reported in Table XIX.

TABLE XIX

| Ingredient | Control | KC | KBC | KCl | KG | KCIT | KC/KBC |
|---|---|---|---|---|---|---|---|
| Water | 87.75 | 86.87 | 86.47 | 86.78 | 84.75 | 86.38 | 86.67 |
| Modified Starch | 6.67 | 6.67 | 6.67 | 6.67 | 6.67 | 6.67 | 6.67 |
| Oil | 2.66 | 2.66 | 2.66 | 2.66 | 2.66 | 2.66 | 2.66 |
| Tomato Juice Conc. | 1.67 | 1.67 | 1.67 | 1.67 | 1.67 | 1.67 | 1.67 |
| Hydrolyzed Plant | 1.25 | 1.25 | 1.25 | 1.25 | 1.25 | 1.25 | 1.25 |
| Protein HPP 7832 | | | | | | | |
| KC | 0.00 | 0.88 | 0.00 | 0.00 | 0.00 | 0.00 | 0.44 |
| KBC | 0.00 | 0.00 | 1.28 | 0.00 | 0.00 | 0.00 | 0.64 |
| KCl | 0.00 | 0.00 | 0.00 | 0.97 | 0.00 | 0.00 | 0.00 |
| KG | 0.00 | 0.00 | 0.00 | 0.00 | 3.00 | 0.00 | 0.00 |
| KCIT | 0.00 | 0.00 | 0.00 | 0.00 | 0.00 | 1.37 | 0.00 |
| Sensory Attributes | Control | KC | KBC | KCl | KG | KCIT | KC/KBC |
| Overall Flavor | 5 | 2 | 6.5 | 5 | 6.8 | 5 | 4 |
| Bitterness | 0 | 3 | 0 | 1.5 | 0 | 1 | 1 |
| Other | 0 | 4 | 0 | 2 | 0 | 1.8 | |
| | | fishy | less | metallic | | Sour | fishy |
| | | | sour | sour | | | |
| | | | Sweeter | | | | |

Once again, potassium bicarbonate imparts the substantial flavor enhancement to the control product, while all others (aside from KG) have undesirable notes or do not increase the overall flavor perception.

### Example 17

### Breads

Bread product formulations were prepared according to the formulations set forth in Table XX, where the amounts given are set forth in grams. The various potassium salts are used in amounts to deliver the same amount of potassium per serving in all cases. A sensory test is then conducted for appearance, crumb, structure, sweet, sour, salty, bitter and other. The results are reported in Table XX.

TABLE XX

| | | | Acid + | | Acid + | |
|---|---|---|---|---|---|---|
| Ingredient | Control | KC | KC | KBC | KBC | KCl |
| Water | 30.81 | 29.74 | 29.24 | 29.27 | 29.38 | 29.65 |
| Bread Flour | 61.28 | 61.28 | 61.28 | 61.28 | 61.28 | 61.28 |
| Buffer, unsalted | 1.75 | 1.75 | 1.75 | 1.75 | 1.75 | 1.75 |
| Salt | 0.47 | 0.47 | 0.47 | 0.47 | 0.47 | 0.47 |
| Sugar, fine gran | 3.50 | 3.50 | 3.50 | 3.50 | 3.50 | 3.50 |
| Non fat milk solid | 1.07 | 1.07 | 1.07 | 1.07 | 1.07 | 1.07 |
| Bakers yeast (dry) | 1.12 | 1.12 | 1.12 | 1.12 | 1.12 | 1.12 |
| Citric Acid | 0.00 | 0.00 | 0.50 | 0.00 | 0.89 | 0.00 |
| KC | 0.00 | 1.07 | 1.07 | 0.00 | 0.00 | 0.00 |
| KBC | 0.00 | 0.00 | 0.00 | 1.54 | 1.54 | 0.00 |
| KCl | 0.00 | 0.00 | 0.00 | 0.00 | 0.00 | 1.16 |
| Sensory | | | Acid + | | Acid + | |
| Attributes | Control | KC | KC | KBC | KBC | KCl |
| Apprearance | Typical | Very Dense | Dense | Golden brown | Slight | like control |
| Crumb | | Tough | Tough | Tight | tan | denser bottom |
| Structure | | Yeasty | fish aroma | Very dense | | |
| | | fish aroma | | | | |
| Sweet | 1 | 1 | 1 | 1 | 1 | 1 |
| Sour | 0 | 0 | 0 | 0 | 0 | 0 |
| Salty | 1 | 0 | 0 | 1 | 1 | 2 |
| Bitter | 0 | 0 | 0 | 0 | 0 | 2.9 |
| Other | 0 | 2 | 1 | 0 | 0 | 0 |
| Description | | fishy | fishy | | | |
| Overall Quality | 6 | 1.4 | 1.8 | 3 | 3.8 | 1.6 |

Moisture loss on baking = about 14%
58 grams of dough yields about 50 grams of baked bread.

### Example 18

### Corn Flakes

Corn Flake product formulations were prepared according to the formulations set forth in Table XXI, where the amounts given are set forth in grams. The various potassium salts are used in amounts to deliver the same amount of potassium per serving in all cases.

TABLE XXI

| | | | Acid + | | Acid + | |
|---|---|---|---|---|---|---|
| Ingredient | Control | KC | KC | KBC | KBC | KCl |
| Yellow Corn | 86.75 | 84.54 | 83.50 | 83.55 | 81.71 | 84.34 |
| Gritts | | | | | | |
| High Fructose | 11.00 | 11.00 | 11.00 | 11.00 | 11.00 | 11.00 |
| Corn Syrup | | | | | | |
| Salt | 1.25 | 1.25 | 1.25 | 1.25 | 1.25 | 1.25 |
| Malt Extract, dark | 1.00 | 1.00 | 1.00 | 1.00 | 1.00 | 1.00 |
| Citric Acid | 0.00 | 0.00 | 1.04 | 0.00 | 1.84 | 0.00 |
| KC | 0.00 | 2.21 | 2.21 | 0.00 | 0.00 | 0.00 |
| KBC | 0.00 | 0.00 | 0.00 | 3.20 | 3.20 | 0.00 |
| KCl | 0.00 | 0.00 | 0.00 | 0.00 | 0.00 | 2.41 |

The flakes with potassium carbonate added were dark in appearance and had a slight aftertaste. The flakes with potassium chloride had an unacceptable metallic, bitter aftertaste. However, the flakes with potassium bicarbonate added were very similar to the control product with no perceived aftertaste.

### Example 19

### Wheat Bran Flakes

Wheat Bran Flake product formulations were prepared according to the formulations set forth in Table XXII, where the amounts given are set forth in grams. The various potassium salts are used in amounts to deliver the same amount of potassium per serving in all cases.

TABLE XXII

| Ingredient | Control | KC | KBC | KCl |
|---|---|---|---|---|
| Wheat Bran | 86.00 | 84.76 | 84.21 | 84.65 |
| High Fructose | 12.00 | 12.00 | 12.00 | 12.00 |
| Corn Syrup | | | | |
| Malt Extract, dark | 1.00 | 1.00 | 1.00 | 1.00 |
| Monosodium phosphate | 1.00 | 1.00 | 1.00 | 1.00 |
| KC | 0.00 | 1.24 | 0.00 | 0.00 |
| KBC | 0.00 | 0.00 | 1.79 | 0.00 |
| KCl | 0.00 | 0.00 | 0.00 | 1.35 |

The flakes with potassium carbonate added were dark in appearance and had an aftertaste. The flakes with potassium chloride were similar to control but had had a metallic, bitter aftertaste. The flakes with potassium bicarbonate added were darker than control, but had no aftertaste.

### Example 20

### Muffins

Muffin product formulations were prepared according to the formulations set forth in Table XXIII, where the amounts given are set forth in grams. The various potassium salts are used in amounts to deliver the same amount of potassium per serving in all cases. Sensory evaluations were performed and are reported in Table XXIII.

Table XXIII

| | | | Acid + | | Acid + | |
|---|---|---|---|---|---|---|
| Ingredient | Control | KC | KC | KBC | KBC | KCl |
| Sugar, fine gran. | 17.39 | 17.39 | 17.39 | 17.39 | 17.39 | 17.39 |
| Salt | 0.21 | 0.21 | 0.21 | 0.21 | 0.21 | 0.21 |
| Nonfat milk | 3.00 | 3.00 | 3.00 | 3.00 | 3.00 | 3.00 |
| solids | | | | | | |
| Vegetable | 3.60 | 3.60 | 3.60 | 3.60 | 3.60 | 3.60 |
| Shorten. | | | | | | |
| Liquid Whole | 7.83 | 7.83 | 7.83 | 7.83 | 7.83 | 7.83 |
| Eggs | | | | | | |
| Water | 31.59 | 30.56 | 30.08 | 30.10 | 29.24 | 30.46 |
| Flour, all | 33.38 | 33.38 | 33.38 | 33.38 | 33.38 | 33.38 |
| purpose | | | | | | |
| Baking Powder | 1.50 | 1.50 | 1.50 | 1.50 | 1.50 | 1.50 |
| Starch | 1.50 | 1.50 | 1.50 | 1.50 | 1.50 | 1.50 |
| Citric Acid, | 0.00 | 0.00 | 0.48 | 0.00 | 0.86 | 0.00 |
| fine gran. | | | | | | |
| KC | 0.00 | 1.03 | 1.03 | 0.00 | 0.00 | 0.00 |
| KBC | 0.00 | 0.00 | 0.00 | 1.49 | 1.49 | 0.00 |
| KCl | 0.00 | 0.00 | 0.00 | 0.00 | 0.00 | 1.13 |

Moisture loss on baking is about 10%. 60 grams of dough yields 55 grams of baked product.

The muffins with potassium carbonate added were similar to control in texture and appearance, but the taste was bitter and metallic. The potassium carbonate muffins were darker and had a noticeable fishy aroma and taste. The addition of the acid helped to correct some of these deficiencies, but the product was still inferior to control. In contrast, even without the acid addition, the muffins with potassium bicarbonate were acceptable. When acid and potassium bicarbonate were used, the muffins were very similar to control in general appearance, color and texture.

I/we claim:

1. A sweetened composition selected from the group oral compositions and ingestible compositions wherein said sweetened composition comprises a sweetening or sweetness enhancing effective amount of potassium bicarbonate.

2. The composition of claim 1 selected from the group consisting of a food product, a beverage, a chewing gum, an oral care product, and an additive product for addition to any of the foregoing types of products.

3. The composition of claim 1 wherein said composition is a liquid product or a product to be diluted or reconstituted into a liquid product and said potassium bicarbonate is included therein in an amount sufficient to deliver up to about 1000 mg of potassium per 100 g of said liquid product or said product after dilution or reconstitution in accordance with the normal instructions for use thereof.

4. The composition of claim 1 wherein said composition is a beverage and potassium bicarbonate has been utilized in the formulation of said beverage in an amount of up to about 1000 mg potassium per 100 g of said beverage.

5. The composition of claim 4 wherein said potassium bicarbonate has been utilized in the formulation of said beverage in an amount of at least about 10 mg potassium per 100 g of said beverage.

6. The composition of claim 1 further comprising an additional sweetener.

7. The composition of claim 1 wherein said composition is a food product wherein said potassium bicarbonate has been utilized in the preparation of said food product in an amount of up to about 1000 mg of potassium per 100 g of said food product.

8. The composition of claim 7 wherein said composition is a food product wherein said potassium bicarbonate has been utilized in the preparation of said food product in an amount of at least about 10 mg of potassium per serving size.

9. The composition of claim 1 wherein said composition is a chewing gum or an oral care product wherein said potassium bicarbonate has been utilized in the preparation of said chewing gum or an oral care product in an amount of up to about 1000 mg of potassium per 100 g of said chewing gum or said oral care product.

10. The composition of claim 9 wherein said composition is a chewing gum or an oral care product wherein said potassium bicarbonate has been utilized in the preparation of said chewing gum or an oral care product in an amount of at least about 10 mg of potassium per 100 g of said chewing gum or said oral care product.

11. The composition of claim 1 wherein said additive for an oral care or ingestible product comprising potassium bicarbonate and a carrier therefor.

12. The composition of claim 11 wherein said carrier is selected from inert carriers, nutritive sweeteners, and non-nutritive sweeteners.

13. A method of making a sweetened oral product or a sweetened ingestible composition comprising incorporating into said composition a sweetening or sweetener enhancing effective amount of potassium bicarbonate.

14. A method of sweetening a composition selected from an ingestible product, or oral product, and an oral care product comprising adding to a formulation for said composition a sweetening or sweetness enhancing effective amount of potassium bicarbonate as the only sweetener, or in combination with other nutritive and/or non-nutritive sweeteners.

15. A method of reducing the amount of sweetener in a composition, comprising replacing a portion or all of said sweetener with a sweetening or sweetness enhnacing effective amount of potassium bicarbonate.
